(19) United States
(12) Patent Application Publication
(10) Pub. No.: US 2023/0222012 A1
(43) Pub. Date: Jul. 13, 2023

(54) METHOD FOR SCALING UP MICROSERVICES BASED ON API CALL TRACING HISTORY

(71) Applicant: Dell Products L.P., Round Rock, TX (US)

(72) Inventors: XiaoJun WU, Shanghai (CN); Muzhar S. KHOKHAR, Shrewsbury, MA (US); HaiJun ZHONG, Shanghai (CN)

(73) Assignee: Dell Products L.P., Round Rock, TX (US)

(21) Appl. No.: 17/574,277

(22) Filed: Jan. 12, 2022

(51) Int. Cl. G06F 9/54

(52) U.S. Cl. CPC G06F 9/541

(57) ABSTRACT

A disclosed microservice scaling operation obtains information indicating dependencies between a function associated with an external API call and microservices spanned by the external API call. Functions invoked by managed resources are monitored and, responsive to detecting the function being invoked, a scaling service is launched to access the dependency information, identify the applicable microservices, and perform a scale up operation instantiating each of the microservices. The dependency information may be obtained by recording and analyzing traces for instances of the external API call to determine a dependency tree that indicates branches spanned by the external API call and a sequence of microservices corresponding to each branch. The microservices may be scaled up in parallel or in a prioritized parallel manner wherein in early span microservices are launched before late span microservices. The API may be a RESTful API and each microservice may correspond to an internal API call.

### TECHNICAL FIELD

The present disclosure relates to information handling systems and, more specifically, information handling system software applications including microservice-based applications.

### BACKGROUND

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Information handling systems may be implemented as distributed systems in which two or more information handling components coordinate to execute a function, service, or application. Edge computing is an increasingly pervasive type of distributed computing in which raw data collected by network-enabled sensors and the like is sent to one or more nearby servers, generally referred to as edge servers, which process the raw data and forward the resulting information to cloud-based compute and storage resources for analysis, forecasting, and other purposes, often aided by machine learning algorithms and other types of artificial intelligence.

Edge resources, including edge servers, may face capacity and performance constraints. In the context of microservice based applications, such constraints may limit the number of active microservices that an edge server can support and may result in delay when a new function is invoked by a user as the server must instantiate the microservices associated with each function. In addition, because it is generally difficult to predict accurately when a user might request a particular function, microservices are launched in a purely reactive fashion that may potentially decrease overall performance and user experience.

### SUMMARY

In accordance with disclosed teachings, a microservice scale up method, system, and computer readable medium generates, accesses, or otherwise obtains information indicating dependencies between a function associated with an external API call and microservices spanned by the external API call. Managed resources are monitored and, upon detecting the function being invoked, a scaling service is launched to access the dependency information, identify the applicable microservices, and perform a scale up operation instantiating some or all of the microservices. The dependency information may be obtained by recording and analyzing traces for instances of the external API call to determine a dependency tree that indicates branches spanned by the external API call and a sequence of microservices corresponding to each branch. The microservices may be scaled up in parallel or in a modified parallel manner wherein one subgroup of the microservices is launched before another subgroup of the microservices. The API may be a RESTful API and each microservice may correspond to an internal API call.

Technical advantages of the present disclosure may be readily apparent to one skilled in the art from the figures, description and claims included herein. The objects and advantages of the embodiments will be realized and achieved at least by the elements, features, and combinations particularly pointed out in the claims.

It is to be understood that both the foregoing general description and the following detailed description are examples and explanatory and are not restrictive of the claims set forth in this disclosure.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 illustrates a method for scaling up microservices in accordance with disclosed teachings;

FIG. 2 illustrates resources for determining dependencies between functions and microservices;

FIG. 3 illustrates an exemplary equation for defining the dependencies determined in FIG. 2;

FIG. 4 illustrates an assembly of resources for performing efficient scale up of microservices in accordance with disclosed teachings;

FIG. 5 illustrates an exemplary equation for defining dependency tree information;

FIG. 6 illustrates an exemplary equation for determining a response time for a user function in accordance with disclosed teachings; and

FIG. 7 illustrates a block diagram of an information handling system.

### DETAILED DESCRIPTION

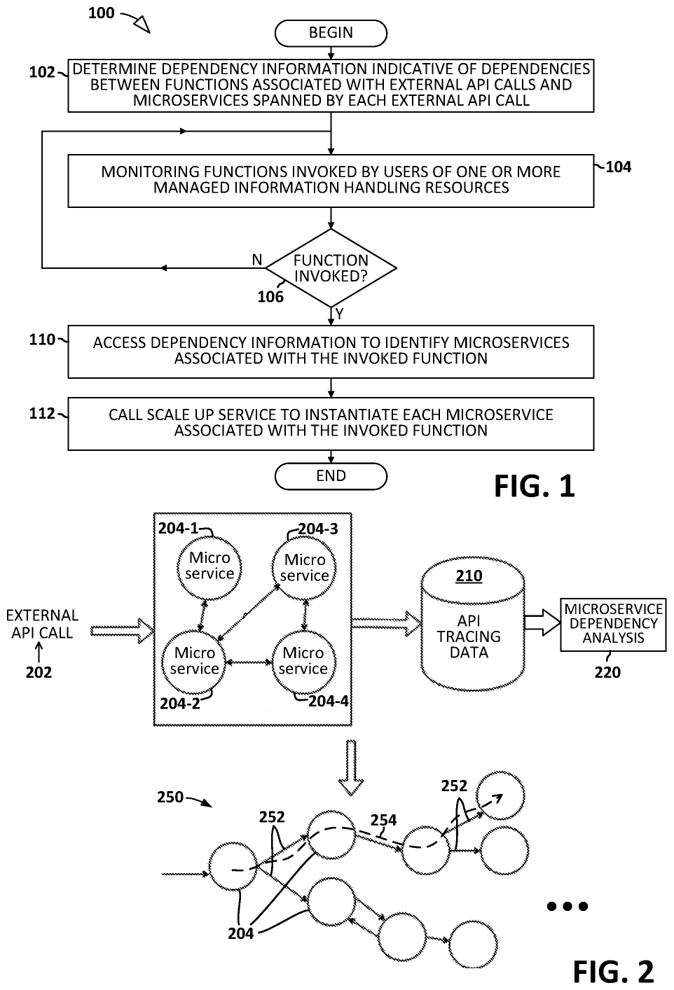

Exemplary embodiments and their advantages are best understood by reference to FIGS. 1-7, wherein like numbers are used to indicate like and corresponding parts unless expressly indicated otherwise.

For the purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, an information handling system may be a personal computer, a personal digital assistant (PDA), a consumer electronic device, a network storage device, or any other suitable device and may vary in size, shape, performance, functionality, and price. The information handling system may include memory, one or more processing resources such as a central processing unit (“CPU”), microcontroller, or hardware or software control logic. Additional components of the information handling system may include one or more storage devices, one or more communications ports for communicating with external devices as well as various input/output (“I/O”) devices, such as a keyboard, a mouse, and a video display. The information handling system may also include one or more buses operable to transmit communication between the various hardware components.

Additionally, an information handling system may include firmware for controlling and/or communicating with, for example, hard drives, network circuitry, memory devices, I/O devices, and other peripheral devices. For example, the hypervisor and/or other components may comprise firmware. As used in this disclosure, firmware includes software embedded in an information handling system component used to perform predefined tasks. Firmware is commonly stored in non-volatile memory, or memory that does not lose stored data upon the loss of power. In certain embodiments, firmware associated with an information handling system component is stored in non-volatile memory that is accessible to one or more information handling system components. In the same or alternative embodiments, firmware associated with an information handling system component is stored in non-volatile memory that is dedicated to and comprises part of that component.

For the purposes of this disclosure, computer-readable media may include any instrumentality or aggregation of instrumentalities that may retain data and/or instructions for a period of time. Computer-readable media may include, without limitation, storage media such as a direct access storage device (e.g., a hard disk drive or floppy disk), a sequential access storage device (e.g., a tape disk drive), compact disk, CD-ROM, DVD, random access memory (RAM), read-only memory (ROM), electrically erasable programmable read-only memory (EEPROM), and/or flash memory; as well as communications media such as wires, optical fibers, microwaves, radio waves, and other electromagnetic and/or optical carriers; and/or any combination of the foregoing.

For the purposes of this disclosure, information handling resources may broadly refer to any component system, device or apparatus of an information handling system, including without limitation processors, service processors, basic input/output systems (BIOSs), buses, memories, I/O devices and/or interfaces, storage resources, network interfaces, motherboards, and/or any other components and/or elements of an information handling system.

In the following description, details are set forth by way of example to facilitate discussion of the disclosed subject matter. It should be apparent to a person of ordinary skill in the field, however, that the disclosed embodiments are exemplary and not exhaustive of all possible embodiments.

Throughout this disclosure, a hyphenated form of a reference numeral refers to a specific instance of an element and the un-hyphenated form of the reference numeral refers to the element generically. Thus, for example, “device 12-1” refers to an instance of a device class, which may be referred to collectively as “devices 12” and any one of which may be referred to generically as “a device 12”.

As used herein, when two or more elements are referred to as “coupled” to one another, such term indicates that such two or more elements are in electronic communication, mechanical communication, including thermal and fluidic communication, thermal, communication or mechanical communication, as applicable, whether connected indirectly or directly, with or without intervening elements.

Referring now to the drawings, FIG. 1 illustrates a block diagram of a method 100 for efficient scale up of microservices associated with a user function. The method 100 illustrated in FIG. 1 is suitable for use in conjunction with a microservice architecture that implements at least one user function via an external API call. The external API call, when made, spans a sequence of internal API calls, some or all of which are associated with a corresponding microservice. Method 100 may be performed by a management resource configured to manage one or more edge servers in an edge computing implementation. It will, however, be appreciated by those of ordinary skill in the field of distributed computing that references made herein to an edge computing environment, and details related thereto, are included for illustrative, rather than limiting purposes.

The illustrated method 100 includes a learning or acquisition phase, described below in reference to FIG. 2, during which the management resource accesses or otherwise obtains (block 102) microservice dependency information associated with a user function. In at least some embodiments, the microservice dependency information, as suggested by its name, indicates a dependency between a user function associated with an external API call and a plurality of microservices spanned by the external API call.

The method 100 of FIG. 1 further includes an operation phase during which the management resource monitors (block 104) functions invoked by users of one or more managed information handling resources. When the management resource detects (block 106) a particular user function being invoked, the management resource accesses (block 110) the dependency information to identify the microservices associated with the invoked function. The management resource then calls (block 112) a scale up service to efficiently activate one or more instances of some or all of the microservices associated with the invoked function. In this context, efficiency may include a reduction or minimization of scale up delay, i.e., the time required to activate an instance of a microservice.

In at least one embodiment, efficiency is achieved by scaling up at least one instance of all of the applicable microservices in parallel to reduce the overall scale up delay associated with a conventional configuration, in which microservices are activated sequentially, one-at-a-time, as the internal API call corresponding to each span of the function is made. Other embodiments may achieve a potentially lesser, but still significant, degree of efficiency by scaling up sub-groups of the microservices in parallel. For example, if a user function spans a sequence of four microservices, the scale up operation may, as an alternative to scaling up all four microservices in parallel, scale up a first subgroup, e.g., the first two microservices, in parallel and then, while the first and second microservices are executing, scale up second subgroup, i.e., the third and fourth microservices, in parallel. In this example, the use of subgroups to scale up the required microservices in two, rather than one, parallel operations, may result in little or no additional scale up delay if the time required to execute the first two microservices is longer than the time required to scale up the third and fourth microservices. The management resource may, in at least some embodiments, be configured to define one or more microservice subgroups and to perform a parallel scale up operation for each subgroup.

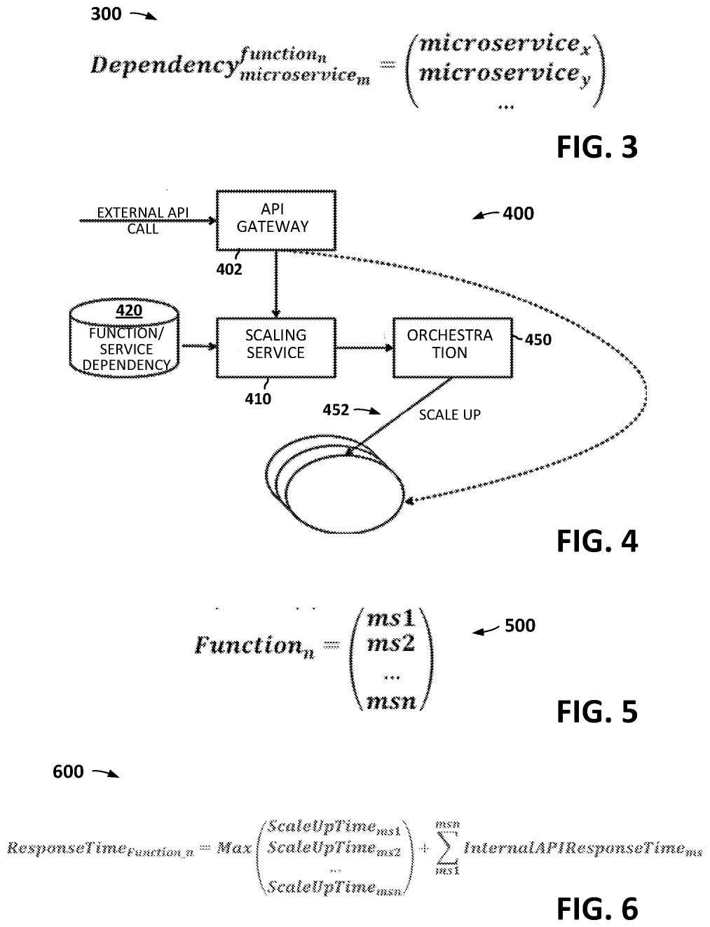

Referring now to FIG. 2, an exemplary determination of dependency information, as performed in block 102 of FIG. 1, is graphically illustrated. In at least some embodiments, the dependency information is defined, in accordance with the definition 300 illustrated in FIG. 3, as a set of microservices associated with a particular function. An external API call 202 results in a series of internal API calls corresponding to a group of microservices 204, four of which are illustrated in FIG. 2 as microservices 204-1 through 204-4. Each time the user function is invoked, some or all of the microservices 204 may be activated and executed. In some implementations, the external API call may always result in the same sequence of internal API calls and their corresponding microservices 204. In other embodiments, the sequence of microservices may vary based, as an illustrative example, on conditional branches included in one or more of the microservices 204. Thus, it may not be possible to identify a complete list of microservices associated with the applicable function by identifying the microservices associated with any single instance of the function. In such cases, the dependency information for a given user function may be learned over time based on multiple instances of the function call.

In at least some embodiments, the external and internal APIs associated with the external an internal API calls illustrated in FIG. 2 may comply with a representational state transfer (REST) model well known to those of ordinary skill in the field. In these embodiments, the REST-compliant APIs may be referred to as RESTful APIs.

At least some embodiments that employ RESTful APIs may leverage RESTful API tracing tools including, as an illustrative and non-limiting example, VMware Tanzu Observability software, to develop a database 210 of API tracing data. FIG. 2 further illustrates a microservice dependency analysis resource 220 configured to analyze API tracing data 210 to generate or otherwise determine information indicative of a dependency tree 250 for the corresponding user function. In some embodiments, the dependency tree 250 information may be defined in accordance with the equation 500 illustrated in FIG. 5, identifying the microservices associated with a corresponding user function.

The dependency tree information may include information indicative of one or more branches 252 that a user function might follow as well as the sequence of microservices 204 executed within each branch. In some embodiments, branch information may include probability information indicating the likelihood that any particular branch is followed. In these embodiments, the branch probability information may be used to define one or more microservice subgroups wherein, as discussed previously, parallel scale up operations are performed for each of two or more microservice subgroups. As an example, if the particular sequence of microservices, represented in FIG. 2 by reference numeral 254, is the most likely sequence of microservices that will be executed during any given invocation of the user function, the corresponding sequence of microservices may be identified as the primary subgroup for the function and, when the function is invoked, the microservices for the primary subgroup may be activated in parallel before activating any remaining microservices.

Turning now to FIG. 4, an exemplary assembly 400 of resources suitable for carrying out efficient scale up of microservices as described herein is illustrated. The illustrated assembly includes an API gateway 402 configured to monitor external API calls 404 as they are made. When API gateway 402 detects a particular external API call corresponding a particular user function, API gateway 402 calls a scale up service 410 and indicates the particular user function and/or external API call. The illustrated scaling service 410 is configured to access function/microservice data 420 to identify the group or subgroup of microservices that will be efficiently scaled up, e.g., scaled up in parallel. The list of microservices to be efficiently scaled up is provided to an orchestration resource 450 that performs the actual parallel instantiation 452 of each identified microservice.

FIG. 6 illustrates an equation 600 conveying an aspect of efficient microservice scale up as described herein. The response time for any given function is defined, in accordance with equation 600, as the sum of a scale up term 602 and a response time term 604. Advantageously, the scale up term 604 is defined as the maximum scale up time for the group of microservices associated with the function rather than a sum of the scale up delay for each microservice as would be expected in conventional scale up implementations. In other words, the scale up term 602 includes the scale up delay for just one microservice.

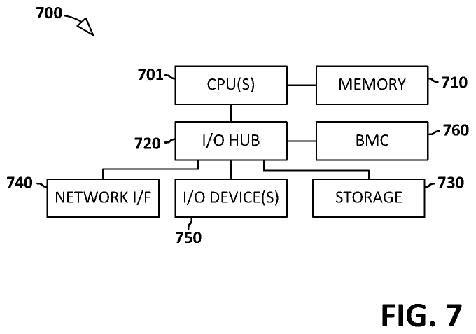

Referring now to FIG. 7, any one or more of the operations or components illustrated in FIG. 1, FIG. 2, OR FIG. 3 may implanted as or within an information handling system exemplified by the information handling system 700 illustrated in FIG. 7. The illustrated information handling system includes one or more general purpose processors or central processing units (CPUs) 701 communicatively coupled to a memory resource 710 and to an input/output hub 720 to which various I/O resources and/or components are communicatively coupled. The I/O resources explicitly depicted in FIG. 7 include a network interface 740, commonly referred to as a NIC (network interface card), storage resources 730, and additional I/O devices, components, or resources 750 including as non-limiting examples, keyboards, mice, displays, printers, speakers, microphones, etc. The illustrated information handling system 700 includes a baseboard management controller (BMC) 760 providing, among other features and services, an out-of-band management resource which may be coupled to a management server (not depicted). In at least some embodiments, BMC 760 may manage information handling system 700 even when information handling system 700 is powered off or powered to a standby state. BMC 760 may include a processor, memory, an out-of-band network interface separate from and physically isolated from an in-band network interface of information handling system 700, and/or other embedded information handling resources. In certain embodiments, BMC 760 may include or may be an integral part of a remote access controller (e.g., a Dell Remote Access Controller or Integrated Dell Remote Access Controller) or a chassis management controller.

This disclosure encompasses all changes, substitutions, variations, alterations, and modifications to the example embodiments herein that a person having ordinary skill in the art would comprehend. Similarly, where appropriate, the appended claims encompass all changes, substitutions, variations, alterations, and modifications to the example embodiments herein that a person having ordinary skill in the art would comprehend. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative.

All examples and conditional language recited herein are intended for pedagogical objects to aid the reader in understanding the disclosure and the concepts contributed by the inventor to furthering the art, and are construed as being without limitation to such specifically recited examples and conditions. Although embodiments of the present disclosure have been described in detail, it should be understood that various changes, substitutions, and alterations could be made hereto without departing from the spirit and scope of the disclosure.

What is claimed is:

1. A microservice scale up method, comprising:
obtaining dependency information indicative of a dependency between a particular function associated with a particular external API call and a plurality of microservices spanned by the particular external API call;
monitoring functions invoked by one or more managed information handling resources;
responsive to detecting an invocation of the particular function, launching a scaling service configured to:
access the dependency information to identify the plurality of microservices; and
performing a scale up operation to instantiate one or more instances of the plurality of microservices.

2. The method of claim 1, wherein obtaining the dependency information comprises:
recording traces for each of one or more instances of the particular external API call; and
analyzing the traces to determine a dependency tree corresponding to the external API call, wherein the dependency tree is indicative of the branches the external API may span and a sequence of microservices corresponding to each branch.

3. The method of claim 1, wherein the scale up operation instantiates each of the one or more microservices in parallel.

4. The method of claim 1, wherein the scale up operation instantiates the one or more microservices based on the sequencing of one or more microservice.

5. The method of claim 1, wherein each of the plurality of microservices corresponds to an internal API call.

6. The method of claim 5, wherein the API comprises a (REST) compliant API.

7. An information handling system, comprising:
a central processing unit (CPU); and
an non-transitory memory resource accessible to the CPU and including one or more processor-executable instructions for performing coordinated microservice scaling operations comprising:
obtaining dependency information indicative of a dependency between a particular function associated with a particular external API call and a plurality of microservices spanned by the particular external API call;
monitoring functions invoked by one or more managed information handling resources;
responsive to detecting an invocation of the particular function, launching a scaling service configured to:
access the dependency information to identify the plurality of microservices; and
performing a scale up operation to instantiate one or more instances of the plurality of microservices.

8. The information handling system of claim 7, wherein obtaining the dependency information comprises:
recording traces for each of one or more instances of the particular external API call; and
analyzing the traces to determine a dependency tree corresponding to the external API call, wherein the dependency tree is indicative of the branches the external API may span and a sequence of microservices corresponding to each branch.

9. The information handling system of claim 7, wherein the scale up operation instantiates each of the one or more microservices in parallel.

10. The information handling system of claim 7, wherein the scale up operation instantiates the one or more microservices based on the sequencing of one or more microservice.

11. The information handling system of claim 7, wherein each of the plurality of microservices corresponds to an internal API call.

12. The information handling system of claim 11, wherein the API comprises a (REST) compliant API.

13. An non-transitory computer readable medium including processor-executable instructions that, when executed by a processor, cause the processor to perform coordinated microservice scaling operations, wherein the coordinated microservice scaling operations include:
obtaining dependency information indicative of a dependency between a particular function associated with a particular external API call and a plurality of microservices spanned by the particular external API call;
monitoring functions invoked users of one or more managed information handling resources;
responsive to detecting an invocation of the particular function, launching a scaling service configured to:
access the dependency information to identify the plurality of microservices; and
performing a scale up operation to instantiate one or more instances of the plurality of microservices.

14. The non-transitory computer readable medium of claim 13, wherein obtaining the dependency information comprises:
recording traces for each of one or more instances of the particular external API call; and
analyzing the traces to determine a dependency tree corresponding to the external API call, wherein the dependency tree is indicative of the branches the external API may span and a sequence of microservices corresponding to each branch.

15. The non-transitory computer readable medium of claim 13, wherein the scale up operation instantiates each of the one or more microservices in parallel.

16. The non-transitory computer readable medium of claim 13, wherein the scale up operation instantiates the one or more microservices based on the sequencing of one or more microservice.

17. The non-transitory computer readable medium of claim 13, wherein each of the plurality of microservices corresponds to an internal API call.

18. The non-transitory computer readable medium of claim 17, wherein the API comprises a (REST) compliant API.
